(19) United States
(12) Patent Application Publication
(10) Pub. No.: US 2002/0044195 A1
(43) Pub. Date: Apr. 18, 2002

(54) Optical memory head

(76) Inventor: Manami Kuiseko, Kyoto-shi (JP)

Correspondence Address: Barry E. Bretschneider, Morrison & Foerster LLP, Suite 5500, 2000 Pennsylvania Avenue, N.W., Washington, DC, 20006-1888, US

(21) Appl. No.: 09/851,434

(22) Filed: May 9, 2001

(30) Foreign Application Priority Data
May 9, 2000 (JP) 2000-135363

(51) Int. Cl. B41J 15/14

(52) U.S. Cl. 347/241

(57) ABSTRACT

An optical memory head for guiding beams of light to an optical memory to be recorded using beams of light. The optical memory head guides beams to an optical memory and includes light sources for emitting beams with different wavelengths. The optical memory head further includes a prism, a collimator lens and a solid immersion lens.

This application claims the benefit of and is based on Application No.2000-135363 filed in Japan, the content of which is hereby incorporated by reference.

### FIELD OF THE INVENTION

The invention relates to optical memory heads and, more particularly, relates to an optical memory head for guiding beams of light to an optical memory that is to be recorded with information by means of beams of light.

### BACKGROUND OF THE INVENTION

Generally, optical systems for use in optical memory heads include a light source for emitting beams to irradiate a memory medium, a collimator lens for forming the beams emitted from the light source into parallel beams and an object lens for focusing the beams from the collimator lens onto the storage layer of a memory. In order to increase the storage density by making the diameter of the optical spot on the optical memory as small as possible, an optical head has been proposed in which a solid immersion lens (SIL) is provided as an object lens for focusing beams onto an irradiation plane which is disposed at a position extremely adjacent to the memory.

Recently, there has been an increased need for higher densities of optical memories and higher speeds in storing and regenerating information. In order to satisfy this need, an optical memory using a photochromic material for the storage layer is beginning to draw attention. The photochromic material is a material the color of which changes corresponding to changes in wavelength of the irradiating beams and in which the optical reflectance and transmittance vary corresponding to changes in color. This characteristic is utilized to store, regenerate or delete information.

For example, in the case where beams having a first wavelength are used to read information, information is stored by changing the reflectance of the memory medium material relative to the beams having a first wavelength using beams having a second wavelength; and stored information is deleted by restoring the reflectance of the material relative to the beams having a first wavelength to its original value using beams having a third wavelength. The reflectance beams having a first wavelength used for reading out information are not changed.

In an optical memory head using an optical memory that has a storage layer made of photochromic material which is irradiated by beams having different wavelengths, a plurality of light sources that emit beams having different wavelengths respectively are used in which, by executing ON/OFF control thereof, the wavelengths of the beams used to irradiate the material are altered. It is possible to construct an optical memory head in which a single light source capable of emitting beams having a wide range of wavelengths and a plurality of filters having different spectral transmittances respectively are provided and in which, by changing the filters, the wavelengths of the beams used to irradiate the material are altered. However, in this manner, changing the filters requires a mechanical drive and takes a long time. Therefore, it is not suitable for practical use.

In a construction in which a plurality of light sources is provided, it is necessary to make the optical paths of the beams from the respective light sources coincide with each other. Further, it is necessary to cause the beams from the respective light sources to be focused at an identical spot. It is relatively easy to make the optical paths coincide with each other by using dichroic mirrors having a characteristic of wavelength selectivity, as practiced in a variety of optical apparatus. However, it is not so easy to cause beams having different wavelengths to be focused at an identical spot when considering the critical requirement that the optical memory head must be small in size and light in weight.

For example, in the case where a collimator lens is disposed on the optical path between a dichroic mirror and an object lens and the optical path lengths from each of the light sources to the dichroic mirror are set to identical in length, since the refractive index of the collimator lens varies depending on the wavelength of the beams, it is impossible to form all of the beams into parallel beams, and the focal points thereof produced by the object lens do not coincide with each other. Even when the optical path from each light source to the dichroic mirror is adjusted so that all beams are caused to be parallel beams by the collimator lens, since the refractive index of the object lens varies depending on the wavelength of the beams, the focal points of the beams do not coincide with each other again. The situation is the same even when a collimator lens is disposed between each light source and the dichroic mirror so that the beams from the respective light sources are independently formed into parallel beams. In this case, the entire structure of the head may become large in size.

In the case where a plurality of object lenses is provided so that the object lens can be changed in accordance with the light source, it is possible to make the focal points of the beams coincide with each other. However, in this case, it will not only make the structure larger in size, but also it takes longer to change object lenses, resulting in failure to achieve high speed storage and output of information.

### SUMMARY OF THE INVENTION

The present invention provides an improved optical memory head.

The present invention also provides an optical memory head that is small in size and light in weight but makes it possible to focus a plurality of beams having different wavelengths at the same spot.

These features may be achieved by an optical memory head having a structure including:

An optical memory head for guiding beams to an optical memory that includes a plurality of light sources for emitting beams having different wavelengths, a prism including dichroic films for forming beams from a plurality of light sources into beams that proceed on essentially identical optical paths, a collimator lens for making the beams coming from the plurality of light sources and through the prism into roughly parallel beams and a solid immersion lens of an internal reflection type for focusing beams coming from the plurality of light sources and through the prism by means of reflection only, in which the optical memory head is disposed at a position where the beams emitted from a plurality of light sources are formed into parallel beams by the collimator lens.

According to an embodiment of the present invention, the optical memory head for guiding beams to an optical memory comprises a plurality of light sources for emitting beams having different wavelengths, a prism having dichroic films for making the beams from the plurality of light sources into the beams that proceed along the identical optical path, a collimator lens for making the beams coming from the plurality of the light sources through the prism into roughly parallel beams and an internal reflection type solid immersion lens for focusing the beams coming from the plurality of the light sources through the collimator lens by means of reflection only. The optical memory head is disposed at a position where the beams emitted from the plurality of light sources are made into the beams that have the identical parallelism by means of the collimator lens.

The beams emitted from the respective light sources enter into the prism and are reflected by the dichroic films or pass through the same and are formed into beams that proceed along the same optical path, and then, by transmission through the collimator lens, the beams are formed into parallel beams or beams that are close to parallel beams. As the beams from the respective light sources have different wavelengths, the refraction thereof in the collimator lens is different from each other. However, as the respective light sources are disposed while taking these differences into consideration, the beams are made into beams having identical parallelism. The beams passing through the collimator lens enter the solid immersion lens and are focused onto the outgoing plane thereof. By disposing the outgoing plane of the solid immersion lens at a position close to the optical memory, the solid immersion lens functions as an object lens.

Although the solid immersion lens finally transmits the beams from the collimator lens, the same is intended to focus the beams by reflecting the beams within the lens. Accordingly, the lens does not exert a refractive effect on the beams. Therefore, although the beams from the respective light sources that enter the solid immersion lens have different wavelengths, all of them are made to focus on the same spot. In the case where the beams from the respective light sources are made into perfectly parallel beams by the collimator lens, the incidence place of the collimator lens is a flat plane and is disposed perpendicularly to the optical axis of the collimator lens. Further, in the case where the beams from the respective light sources are not perfectly parallel beams, that is, in case where the beams from the collimator lens are made into convergent beams or divergent beams close to parallel beams, the incidence plane of the collimator lens is made into a slightly convex or concave plane in order to allow the beams to enter perpendicularly to the incidence plane at any point thereon.

It is preferable that the number of the light sources is three or more to five or less. Since number of the dichroic films is a number fewer by one than the number of the light sources, the number thereof is two or more to four or less. By providing three or more light sources, the number of the selectable wavelengths is increased, but by limiting the number of the light sources to five or less, it is possible to form the prism in a simple hexahedron configuration. In the case where the number of the light source is five and the number of dichroic films is four, by forming the prism in cube configuration and by providing dichroic films on the diagonal planes, it is easier to prepare the dichroic films as well as to arrange the positions of the light sources.

It is preferable to provide an actuator for changing the position of the collimator lens in the direction of its optical axis. By changing the position of the collimator lens it is possible to adjust the parallelism of the beams. Also, even when the optical path length varies due to unevenness on the surface of the optical memory, it is possible to irradiate the beams securely within an extremely small range on the optical memory. Further, even when small differences exist among the positions of the respective light sources, it is possible to correct the differences by adjusting the position of the collimator lens.

It is preferable to provide a mirror that reflects the beams coming from the plurality of light sources through the collimator lens and guides the same to the solid immersion lens. It is made possible to fix the light sources, the prism and the collimator lens as well as to make the mirror and the solid immersion lens to be movable.

Herein, it is preferable to provide a construction including a mirror made of a thin film capable of changing its configuration, a supporting member that supports the frame of the mirror and which is filled with a gas or liquid and sealed between itself and the mirror, and a means for changing the curvature of the mirror by changing the pressure of the gas or liquid between the supporting member and the mirror. By changing the curvature of the mirror, it is possible to adjust the parallelism of the beams.

It is preferable to provide a construction including a mirror comprising a polarization spectroscopic mirror, a quaternary wave plate disposed between the mirror and the solid immersion lens and a photodetector disposed at the opposite side of the reflection plane of the mirror. It is possible using this construction to detect the reflected beams from the optical memory at a position adjacent to the optical memory. In this case, the beams from the light sources are linearly polarized beams, and the polarization spectral characteristics are predetermined so that the linearly polarized beams are reflected. The plane of polarization of the linearly polarized beams turns by 90° while passing twice through the quaternary wave plate. Accordingly, the reflected beams from the optical mirror pass through the mirror and are detected by the photodetector.

It is preferable to provide a head main body, an arm supported by the head main body so that it is movable in the direction along the surface of the optical memory and a slider supported by the arm adjacent to the optical memory so that it is movable in the direction perpendicular to the surface of the optical memory; wherein the plurality of light sources, the prism and the collimator lens are attached to the head main body, the mirror is attached to the arm and the solid immersion lens is attached to the slider.

The arm and the slider are the movable parts. By attaching only the solid immersion lens that functions as the object lens to the slider, and by attaching only the mirror that guides the beams to the solid immersion lens to the arm, it is possible to minimize the size and weight of these movable parts. Accordingly, it is possible to move the movable parts at a high speed.

It is preferable to provide a construction in which the solid immersion lens includes a first plane that is a flat plane and a second plane that is a curved plane at the side of the solid immersion lens opposite from the first plane, the beams from the collimator lens are allowed to pass from the first plane without refraction, the beams passing from the first plane are reflected by the second plane toward the center of the first plane, and are further reflected at the center of the first plane to a focus upon the second plane. By making the first plane a flat plane, it is possible to focus the beams with a high accuracy. Further, manufacturing of the solid immersion lens will become easier. In this case, the collimator lens makes the beams from the respective light sources into perfectly parallel beams.

### BRIEF DESCRIPTION OF THE DRAWINGS

These and other advantages and features of this invention will become clear from the following description, taken in conjunction with the embodiments described in this application with reference to the accompanied drawings in which:

FIG. 1 is a schematic view illustrating the entire structure of the optical system of an optical memory head according to a first embodiment of this invention;

FIG. 2 is a partially cut-away view of an arm mounted with a mirror and a quaternary wave plate on the optical memory head of FIG. 1;

FIG. 3 is a view illustrating the structure of the solid immersion lens used in the optical memory head of FIG. 1 and the functional principle relative to a beam from a light source;

FIG. 4 is a view illustrating another structure of solid immersion lens for the optical memory head of FIG. 1 and the functional principle thereof;

FIG. 5 is a view illustrating the structure of another embodiment of the solid immersion lens and the functional principle thereof;

FIG. 6 is a view illustrating a mirror and the surroundings thereof for an optical memory head according to a second embodiment of the invention; and

FIG. 7 is a view illustrating the structure of a prism for making the optical paths from five light sources coincide with each other.

### DETAILED DESCRIPTION OF THE INVENTION

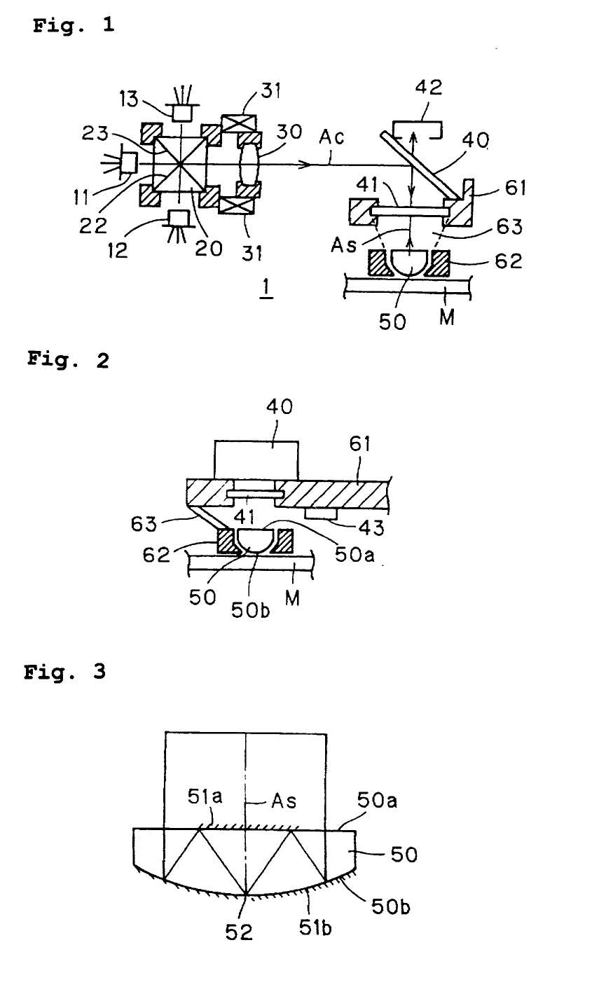

Hereinafter, referring to the drawings, further detailed description will be made as to an embodiment of the optical memory head 1 of the present invention. FIG. 1 illustrates the structure of the optical system on the optical memory head 1 according to a first embodiment. The optical memory head 1 includes three light sources 11, 12, 13, a prism 20, a collimator lens 30, an actuator 31, a mirror 40, a quaternary wave plate 41, a photodetector 42 and a solid immersion lens 50, configured to guide beams to a rotational disk-like optical memory M.

The light sources 11, 12, 13 are, for example, laser diodes that emit beams of light to irradiate the optical memory M and radiate the beams toward the prism 20. The wavelengths of the beams emitted from the light sources 11, 12, 13 are different from each other. Also, the beams emitted by the light sources 11, 12, 13 are linearly polarized beams having specific respective planes of polarization.

The prism 20 is cubic in form and is manufactured by joining four pieces that are isosceles-right triangles in cross section. The adjoining faces of the prism 20 crossing at 90° are provided with dichroic films 22, 23 respectively. The prism 20 is disposed so that the intersection line of the dichroic films 22, 23 intersects the optical axis Ac of the collimator lens perpendicularly. The four surfaces of the prism 20 are parallel with or perpendicular to the optical axis Ac of the collimator lens.

The light source 11 is disposed on the optical axis Ac of the collimator lens 30. The light sources 12, 13 are disposed respectively on the optical axis Ac as it is 15 refracted by the dichroic films 22, 23. The optical axis Ac of the collimator lens 30 is set so as to intersect perpendicularly to the rotation axis of the optical memory M as well as to be parallel with the surface of the optical memory M.

The spectral characteristics of the dichroic film 22 are set so that the beams emitted from the light source 12 are reflected selectively, and the beams emitted from the light sources 11, 13 are allowed to pass through. The spectral characteristics of the dichroic film 23 are set so that the beams emitted from the light source 13 are reflected selectively, and the beams emitted from the light sources 11, 12 are transmitted. Accordingly, the beams emitted by the light source 11 pass through both dichroic films 22, 23 and enter the collimator lens 30. The beams emitted by the light source 12 are reflected by the dichroic film 22, pass through the dichroic film 23 and enter the collimator lens 30. Likewise, the beams emitted by the light source 13 are reflected by dichroic film 23, pass through the dichroic film 22 and enter the collimator lens 30.

The beams emitted by the light sources 11, 12, 13 are divergent beams. The collimator lens 30 reflects these divergent beams and makes them into roughly parallel beams. Since the wavelengths of the beams from the light sources 11, 12, 13 are different from each other; the refraction effects on these beams by the collimator lens 30 are not identical. The optical path lengths from the respective light sources 11, 12, 13 to the collimator lens 30 are predetermined while taking into consideration the wavelengths and angles of divergence of the beams emitted by the respective light sources so that the parallelism of the respective beams after passing through the collimator lens 30 is the same.

The collimator lens 30 is movable in the direction of the optical axis Ac. The actuator 31 is provided for driving the collimator lens 30. The light sources 11, 12, 13, the prism 20 and the actuator 31 are fixed to the main body of the head 1.

The mirror 40 is disposed so as to intersect the optical axis Ac of the collimator lens 30 at an angle of 45° to reflect the beams that are emitted by the light sources 11, 12, 13 and made into roughly parallel beams by the collimator lens 30 and guide the same to the solid immersion lens 50. The mirror 40 is a polarization spectroscopic mirror (PBS) that reflects S-polarized beams and allows P-polarized beams to pass through. The light sources 11, 12, 13 are all adapted so that linear polarized light emitted therefrom is S-polarized light relative to the mirror 40, so that the beams emitted from the light sources 11, 12, 13 are all reflected by the mirror 40.

The quaternary wave plate 41 is disposed so as to intersect perpendicularly to the optical axis Ac of the collimator lens 30 as reflected by the mirror 40. The photodetector 42 is disposed at the opposite side of the quaternary wave plate 41 relative to where the mirror 40 is on the extended line of the optical axis Ac of the collimator lens 30 reflected by the mirror 40.

FIG. 2 illustrates the arm 61 viewed from the optical axis Ac of the collimator lens 30. The mirror 40, the quaternary wave plate 41 and the photodetector 42 are attached to the arm 61 supported by the head main body. The arm 61 is movable in the direction along the optical axis Ac of the collimator lens 30, that is, in the direction of the radius of the optical memory M, the relative positional relationship therebetween being defined by the rotation of the optical memory M and the movement of the arm 61.

The arm 61 is provided with a distance detector 43 for measuring the distance up to the surface of the optical memory M.

The solid immersion lens 50 is adapted so that the optical axis As thereof coincides with the optical axis Ac of the collimator lens 30 reflected by the mirror 40. The solid immersion lens 50 has incidence plane 50a and exit plane 50b at opposite sides thereof. The beams emitted from the light sources 11, 12, 13 and entering into incidence plane 50a are focused on and are emitted from the outgoing plane 50b. However, the solid immersion lens 50 focuses the beams emitted by the light sources 11, 12, 13 not by refracting but by reflecting the beams therein. The structure and the function of the solid immersion lens 50 will be described hereinafter.

The solid immersion lens 50 is attached to a slider 62 supported by the arm 61. The slider 62 is supported by an inclined flexible suspension 63 and is movable in the direction along the optical axis As of the solid immersion lens 50, that is, in the direction perpendicular to the surface of the optical memory M. An extremely small layer of air is interposed between the outgoing plane 50b of the solid immersion lens 50 and the surface of the optical memory M. The slider 62 slides in accordance with unevenness of the surface of the optical memory M so that the layer of air is maintained at a specific thickness. Therefore, the distance between the outgoing plane 50b of the solid immersion lens 50 and the surface of the optical memory M is always maintained at a specific value and is extremely small in size.

The beams emitted by the light sources 11, 12,13 proceed through the prism 20, the collimator lens 30 and the mirror 40 and enter into the quaternary wave plate 41 as roughly parallel beams. The beams are changed from plane-polarized beams to circular-polarized beams by permeating through the quaternary wave plate 41 and are incident on the incidence plane 50a of the solid immersion lens 50. The beams incident on the solid immersion lens 50 are reflected therein and focused on the outgoing plane 50b and emitted from the outgoing plane 50b and form an extremely small spot on the storage layer of the optical memory M extremely close thereto. Information can be written on and deleted from the optical memory M thereby.

To read out information from the optical memory M, reflected beams are used. The beams reflected by the storage layer on the optical memory M proceed along the optical path inversely and reach the mirror 40. That is to say, the reflected beams from the optical memory M incident on the solid immersion lens 50 through the outgoing plane 50b are reflected therein and are emitted from the incidence plane 50a as roughly parallel beams, pass through the quaternary wave plate 41 and are incident on the mirror 40. The reflected beams from the optical memory M are maintained as circular-polarized light until they reach the quaternary wave plate 41; but they are changed into linearly polarized light upon passage through the quaternary wave plate 41. The plane of polarization of the linearly polarized light has been turned by 90° relative to its prior plane of polarization when it is emitted from the light source. Therefore, the reflected beams pass through the mirror 40 and are incident on the photodetector 42, and information is read thereby.

In the case where an optical memory M in which a storage layer is made of a photo chromic material is used, to make the optical head suitable for writing and deleting information, the optical wavelength emitted by the light sources 11, 12, 13 is predetermined in accordance with the material. Also, as a photodetector 42, one sensitive to the wavelength of light used for regeneration is used.

FIG. 3 illustrates the structure of the solid immersion lens 50 and its functional principle with respect to the beams from the light sources 11, 12, 13. FIG. 3 shows an example of a case where the beams from the light sources 11, 12, 13 are formed into essentially perfectly parallel beams by the collimator lens 30. The incidence plane 50a is a plane perpendicular to the optical axis As, and the outgoing plane 50b is a paraboloid of revolution about the center of optical axis As. The thickness of the solid immersion lens 50 is predetermined so that the incidence plane 50a goes through at the midpoint between the vertex of the outgoing plane 50b and the focus point. A reflection film 51a made of a metal such as aluminum or the like is deposited on the incidence plane 50a, likewise a reflection film 51b made of a metal such as aluminum or the like is deposited on the outgoing plane 50b. At the center of the reflection film 51b, i.e., at the vertex of the outgoing plane 50b, an extremely fine opening 52 is formed.

The beams from the light sources 11, 12, 13 pass through the incidence plane 50a and enter the solid immersion lens 50. The angle of incidence is 0° ; accordingly no refraction occurs at incidence. The beams entering therein reach the outgoing plane 50b and are reflected by the reflection film 51 b. The beams reflected at the reflection film 51b proceed toward the focal point of the outgoing plane 50b and reach the incidence plane 50a. The beams reflected by the reflection film 51a deposited on the incidence plane 50a proceed toward the vertex of the outgoing plane 50b and are focused at the vertex. The reflection of beams does not depend on their wavelength. Accordingly, the focal points of the beams from the light sources 11, 12, 13 coincide with each other. The focused beams are emitted from the opening 52 of the reflection film 51b.

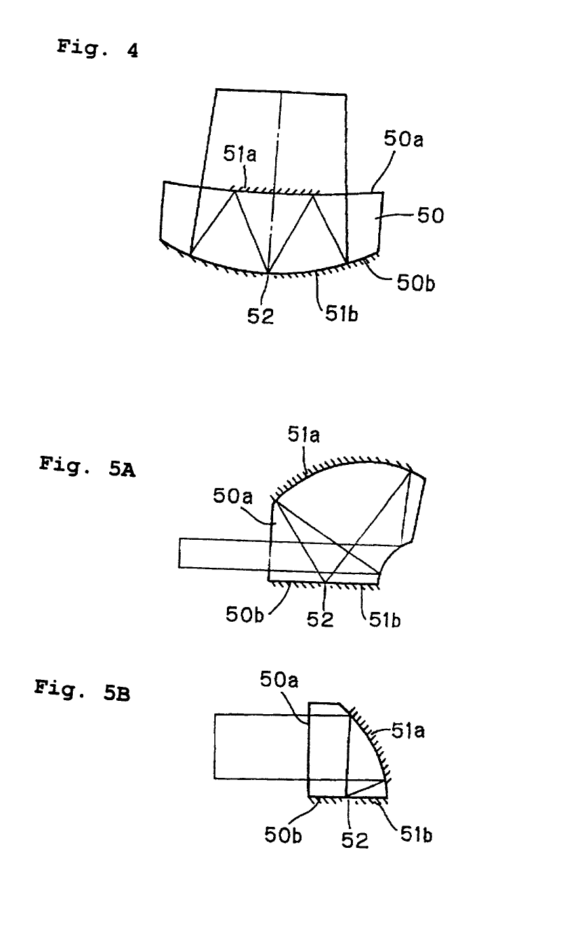

FIG. 4 illustrate the structure of a solid immersion lens 50 in a case where the beams from the light sources 11, 12, 13 are formed into divergent beams that are close to being parallel beams by the collimator lens 30. In this case, the incidence plane 50a is formed into a slightly concave shape so that the angle of incidence is 0° at any point on the incidence plane 50a. It is not shown in the figure but, in the case where the beams from the light sources 11, 12, 13 are formed into convergent beams close to parallel beams by the collimator lens 30, the incidence plane 50a is formed into a slightly convex shape.

In the case where the beams from the light sources 11, 12, 13 are not made perfectly parallel by the collimator lens 30, when the distance between the mirror 40 and the solid immersion lens 50 varies due to unevenness on the surface of the optical memory M, the angle of incidence on the solid immersion lens 50 also varies. However, by changing the position of the collimator lens 30 with the actuator 31 to adjust the parallelism of the beams, it is possible to maintain the angle of incidence on the solid immersion lens 50 at a specific angle so that as the beams can be securely focused on the outgoing plane 50b. Further, even when small differences exist among the disposed positions of the light sources 11, 12, 13, it is possible to correct the differences by changing the position of the collimator lens 30.

Further, it is acceptable to deposit a cholesteric liquid film that allows transmission of circularly polarized light from the quaternary wave plate 41 and reflects circular-polarized light of which rotational direction is reversed. The circular-polarized beams incident on the solid immersion lens 50 after permeating the cholesteric liquid film, are made into a circular-polarized beams of which rotational direction is inverse by being reflected at the reflection film 51 b. Accordingly, the beams from the reflection film 51b are all reflected at the incidence plane 50a, and there is no optical loss.

FIG. 5A and 5B illustrate other embodiments of the solid immersion lens 50. They are adapted so that the incidence plane 50a intersects perpendicular to the outgoing plane 50b.

Hereinafter, a description as to a second embodiment of the optical memory head 2 will be made. In the optical memory head 2 of this embodiment, the actuator 31 provided on the above-described optical memory head 1 is eliminated, and the collimator lens 30 is fixed so that the parallelism of the beams is adjusted by the mirror 40. The structure other than the above is identical to the optical memory head 1, do the components providing the same functions will be indicated by the identical reference numerals and duplicating descriptions will be omitted.

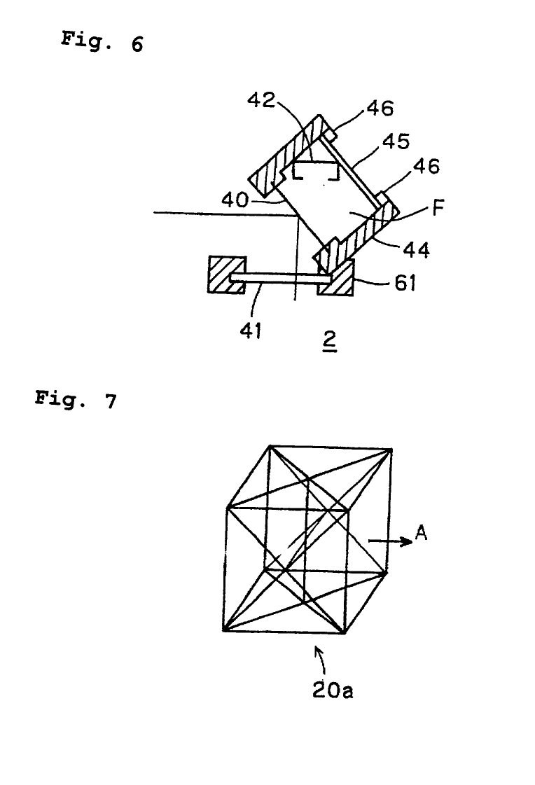

FIG. 6 illustrates the mirror 40 on the optical memory head 2 and their periphery. The mirror 40 is prepared by depositing reflection film of metal such as aluminum or the like on the surface of a thin film of resin. The frame of the mirror 40 is attached air tightly at one end of the support member 44 cylindrical in form. At the other and of the 44 a plate 45 is engaged air tightly. A gas such as air or the like, or a liquid such as water or the like (hereinafter referred to as sealed substance F) is sealed inside of the 44. The plate 45 is movable. An actuator 46 for moving the plate 45 is attached to the support member 44.

The mirror 40 made of a thin film is changeable in form; the curvature thereof changes in response to the pressure of the sealed substance F. Ordinary, the pressure of the sealed substance F is kept equal to the atmospheric pressure to provide the mirror 40 a flat plane figure. When the optical path length up to the solid immersion lens 50 varies due to unevenness of the optical memory M, the movable plate 45 is moved by the actuator 46 to change the pressure of the sealed substance F so that the mirror 40 is convex or concave in form. In this manner, the incident angle on the solid immersion lens 50 can be returned to 0° and the light can be focused on the outgoing plane 50b of the solid immersion lens 50. Also, even when small positional differences among the light sources 11, 12, 13 are present, the differences can be corrected by changing the curvature of the mirror 40.

In the embodiments described above, number of the light sources is assumed to be three, but any number of light sources more than two is acceptable. However, it is preferable that the number of the light sources is less than five to avoid difficulties in preparing the dichroic films used for the prism and/or in arranging of the light sources.

FIG. 7 illustrates a prism for five light sources. This prism 20a is cubic in configuration and the beams are emitted in the direction of the arrow A. On four diagonal faces that intersect with the direction of the arrow A are deposited with dichroic films that have different spectral characteristics respectively. The respective light sources are disposed so as to face toward the five faces excluding the radiation, or exit, face. A prism that has the structure described-above is easy to manufacture as well as to use with respect to the light sources.

In the embodiments hereinbefore, in order to enhance the efficiency of beams in use, a polarization spectroscopic mirror and a quaternary wave plate are used. Another structure in which expensive polarizing elements does not have to be used is also possible. In such a case, the beams emitted by the light sources 11, 12, 13 may be polarized beams or non-polarized beams and the mirror may be a half mirror.

In the optical memory head of the present invention, the optical memory head is provided with a plurality of light sources for emitting beams having different wavelengths, a prism having dichroic films that form the beams from the plurality of light sources into light sources that proceed along the identical optical path and an internal reflection type solid immersion lens for focusing the beams coming from the plurality of light source and through the collimator lens by means of reflection only. The light sources are disposed respectively at the positions where the beams emitted thereby are made into the beams having identical parallelism by the collimator lens. According to the optical memory head of the present invention, it is possible to make the beams from the respective light source enter into the solid immersion lens under identical conditions, at the same time, as the solid immersion lens does not exert any refractive effect upon the beams, so that beams from the respective light sources having different wavelengths are all focused on an identical spot. Further, as the solid immersion lens is used as the object lens, it is made possible to make the optical spot on the optical memory have an extremely small diameter, resulting in a head capable of storing information with a high storage density.

By limiting the number of the light sources to 3 or more or 5 or less, it is possible that while the number of the selectable wavelengths is increased, the prism is formed into a simple hexahedron configuration. Accordingly, it is made easy to prepare the prism and to arrange the light source.

By providing actuators that shift the collimator lens in the direction of the optical axis thereof, it is possible to adjust the parallelism of the beams. Accordingly, even when the optical path length up to the solid immersion lens varies due to unevenness on the surface of the optical memory, it is made possible to securely focus the beams onto the radiation plane of the solid immersion lens. Further, as it is made possible to correct the differences among the positions of the respective light sources, positioning of the light sources becomes easier and manufacturing efficiency is increased.

By providing a mirror that reflects the beams coming from the plurality of light source through the collimator lens and guide the same to the solid immersion lens, it is made possible to make the structure so that the mirror and the solid immersion lens only are provided for the parts to be movable relative to the optical memory. Accordingly, it is made possible to make the movable unit to be lighter in weight resulting in a head capable of a high speed drive.

By providing the structure including the mirror made of a thin film capable of a change of configuration, the supporting member that supports the frame of the mirror and is sealed and filled with a gas or liquid between the same and the mirror, and the capability for changing the curvature of the mirror by changing the pressure of the gas or liquid between the supporting member and the mirror, just like the case where an actuator for driving the collimator lens is provided, it is possible to adjust the parallelism of the beams resulting in an easy arrangement of the light sources.

By providing the structure including a polarization spectroscopic mirror, the quaternary wave plate disposed between the mirror and the solid immersion lens and the photodetector disposed at the opposite side of the reflection plane of the mirror, it is possible to provide a plane head with a high sensitivity capable detecting reflected beams from the optical memory at a position adjacent to the optical memory.

By providing the main body, the arm and the slider, the light sources, the prism and the collimator lens attached to the head main body, the mirror attached to the arm and the solid immersion lens attached to the slider, it is possible to make the slider and the arm with a minimum size and weight resulting in a head capable of operating at high speed.

By providing the solid immersion lens having the structure in which the solid immersion lens has a first flat surface and a second curved surface at the opposite side of the first surface, the beams coming through the collimator lens are allowed to pas through the lens through the first surface without refraction, the beams passing through the first surface thereof are directed toward the center of the first surface by reflecting the same at the second surface thereof, and the beams further reflected at the center of the first surface thereof are focused on the second surface thereof, it is possible to secure accurate focusing of the beams as well as to increase manufacturing efficiency.

Although the present invention has been fully described by way of example with reference to the accompanying drawings, it to be understood that various changes and modifications will be apparent to those skilled in the art. Therefore, unless otherwise such changes and modification depart from the scope of the present invention, they should be construed as being included therein.

What is claimed is:

1. An optical memory device, comprising:
a plurality of light sources for emitting beams having different wavelengths from each other;
a beam integrating element for making beams emitted from the plurality of light sources into beams proceeding on an identical optical path;
a collimator element for making the beams emitted from the beam integrating element into substantially parallel beams; and
an optical head for guiding the beams emitted from the collimator element and focusing the beams on a memory storage, the optical head having a solid immersion element having an internal reflection surface for converging the beams by means of reflection;
wherein each of the plurality of light sources is disposed so that the beams emitted from the plurality of light sources are made into parallel beams by the collimator element.

2. The optical memory device of claim 1 further comprising a mirror disposed on the optical axis of the collimator element so as to intersect the optical axis at a 45 degree angle.

3. The optical memory device of claim 2, wherein the curvature of the surface of the mirror is adjustable by a pressure applied to the mirror.

4. The optical memory device of claim 2, wherein the mirror comprises a polarized beam splitter.

5. The optical memory device of claim 2, wherein the mirror comprises a mirror.

6. An optical memory apparatus, comprising:
a memory storage;
a plurality of light sources for emitting beams having different wavelengths from each other;
a beam integrating element for making beams emitted from the plurality of light sources into beams proceeding on substantially identical optical paths;
a collimator element for making the beams emitted from the beam integrating element into substantially parallel beams; and
an optical head for guiding the beams emitted from the collimator element and focusing the beams on the memory storage, the optical head having a solid immersion element having an internal reflection surface for converging the beams by means of reflection;
wherein each of the plurality of light sources are disposed so that the beams emitted from the plurality of light sources are made into substantially parallel beams by the collimator element.

7. The optical memory apparatus of claim 6 wherein the memory storage comprises a layer of photochromic material.

8. An optical memory device, comprising:
a beam integrating element directing beams onto substantially identical optical paths; and
a collimator element directing the beams emitted from the from the beam integrating element into substantially parallel beams.

9. The optical memory device of claim 8, further comprising:
light sources emitting the beams with different wavelengths; and
an optical head for guiding the beams emitted from the collimator element and focusing the beams on a memory storage, the optical head having a solid immersion element having an internal reflection surface for converging the beams by means of reflection;
wherein each of the light sources are disposed such that the beams emitted from the light sources are formed into parallel beams by the collimator element.

10. A lens, comprising:
an incidence plane perpendicular to an optical axis;
an outgoing plane having a paraboloid of revolution configured with the center of the optical axis;
a first reflection film deposited on the incidence plane; and
a second reflection film, deposited on the outgoing plane and having an opening formed at a vertex of the outgoing plane.

11. The lens of claim 10, further comprising a plurality of light sources:
wherein beams emitted from the light sources permeate the incidence plane, enter the lens, reach the outgoing plane, are reflected by the second reflection film, proceed toward a focal point of the outgoing plane, reach the incidence plane, are reflected by the incidence plane, proceed toward the vertex of the outgoing plane, and are focused at the vertex, such that the focal points of the beams coincide with each other and are emitted from the opening.

12. The lens of claim 11, wherein the lens comprises a solid immersion lens.
